(19) United States
(12) Patent Application Publication
(10) Pub. No.: US 2019/0306580 A1
(43) Pub. Date: Oct. 3, 2019

(54) DISABLING OPERATION OF A REMOTE CONTROL UNIT FOR A MULTIMEDIA DEVICE

(71) Applicant: ARRIS Enterprises LLC, Suwanee, GA (US)

(72) Inventors: Qi Wang, Shanghai (CN); Wanting Yang, Shanghai (CN); Qili Gu, Jiang Su (CN); Hongbin Zhou, Shanghai (CN); Luyan Sun, Shanghai (CN)

(21) Appl. No.: 15/552,121

(22) PCT Filed: Dec. 19, 2016
(86) PCT No.: PCT/CN2016/110858

§ 371 Date: Aug. 18, 2017

(51) Int. Cl. H04N 21/475; H04N 21/422; H04N 21/45; H04N 21/485

(52) U.S. Cl. CPC H04N 21/4753; H04N 21/42222; G06F 21/83; H04N 21/485; H04N 21/4532

(57) ABSTRACT

Methods, systems, and computer readable media may be operable to facilitate a disabling of a remote control unit for a multimedia device. A multimedia device may be configured with a predetermined input for enabling/disabling an input interface of the multimedia device. An interface lock feature may be enabled at the multimedia device, and when the predetermined input is received at the multimedia device, an input interface of the multimedia device may be enabled or disabled. When the input interface of the multimedia device is disabled, a control device such as a remote control unit may be precluded from operating with the multimedia device.

### TECHNICAL FIELD

This disclosure relates to the disabling of a remote control unit for a multimedia device.

### BACKGROUND

Multimedia devices are typically placed in numerous rooms and locations throughout a subscriber premise, and each user within the premise may have access to the multimedia devices at all times. Parents may desire to limit or restrict a child's access to these multimedia devices. For example, children may have difficulty balancing the time that they spend in front of the television, with other activities, including spending time with their family and getting enough sleep. With multimedia devices such as televisions and set-top boxes being installed in a semi-permanent position within rooms of a premise, parents may find it difficult to impose a limitation or restriction of a child's access to these devices. Therefore, a need exists for improving methods and systems for controlling access to multimedia devices.

### BRIEF DESCRIPTION OF THE DRAWINGS

FIG. 1 is a block diagram illustrating an example network environment operable to facilitate a disabling of a remote control unit for a multimedia device.

FIG. 2 is a block diagram illustrating an example multimedia device operable to facilitate a disabling of a remote control unit for the multimedia device.

FIG. 3 is a flowchart illustrating an example process operable to facilitate a disabling of a remote control unit for a multimedia device.

FIG. 4 is a flowchart illustrating an example process operable to facilitate an enabling of a remote control unit for a multimedia device.

FIG. 5 is a flowchart illustrating an example process operable to facilitate an establishing of a key code for enabling and/or disabling an input interface.

FIG. 6 is a block diagram of a hardware configuration operable to facilitate a disabling of a remote control unit for a multimedia device.

Like reference numbers and designations in the various drawings indicate like elements.

### DETAILED DESCRIPTION

It is desirable to improve upon methods and systems for controlling access to multimedia devices. Methods, systems, and computer readable media may be operable to facilitate a disabling of a remote control unit for a multimedia device. A multimedia device may be configured with a predetermined input for enabling/disabling a remote control unit for the multimedia device. An interface lock feature may be enabled at the multimedia device, and when the predetermined input is received at the multimedia device, functionality of a remote control unit for the multimedia device may be enabled or disabled. When the remote control unit for the multimedia device is disabled, the remote control unit may be precluded from operating with the multimedia device.

An embodiment of the invention described herein may include a method comprising: (a) establishing a first predetermined input as an input for disabling an input interface of a multimedia device; (b) receiving the first predetermined input at the multimedia device; and (c) in response to receiving the first predetermined input, disabling the input interface of the multimedia device, wherein disabling the input interface of the multimedia device comprises ignoring communications received through the input interface.

According to an embodiment of the invention, the first predetermined input comprises a user-established string of characters.

According to an embodiment of the invention, the first predetermined input comprises a default string of characters.

According to an embodiment of the invention, the method described herein further comprises: (a) establishing a second predetermined input as an input for enabling the input interface of the multimedia device; (b) receiving the second predetermined input at the multimedia device; and (c) in response to receiving the second predetermined input, enabling the input interface of the multimedia device.

According to an embodiment of the invention, the first predetermined input and the second predetermined input comprise the same string of characters.

According to an embodiment of the invention, disabling the input interface of the multimedia device comprises causing the input interface to ignore communications received through the input interface except for an input of the second predetermined input.

According to an embodiment of the invention, the method described herein further comprises, outputting an indication of the input interface being disabled.

An embodiment of the invention described herein may include an apparatus comprising: (a) a module configured to establish a first predetermined input as an input for disabling an input interface, wherein the input interface is configured to be used to receive the first predetermined input, and wherein the input interface is configured to receive input communications from a user; and (b) wherein the module is further configured to, in response to receiving the first predetermined input, disable the input interface, wherein disabling the input interface comprises ignoring communications received through the input interface.

According to an embodiment of the invention: (a) the module is further configured to establish a second predetermined input as an input for enabling the input interface; (b) the interface is further configured to receive the second predetermined input; and (c) the module is further configured to, in response to receiving the second predetermined input, enable the input interface.

According to an embodiment of the invention, the module is further configured to output an indication of the input interface being disabled.

An embodiment of the invention described herein may include one or more non-transitory computer readable media having instructions operable to cause one or more processors to perform the operations comprising: (a) establishing a first predetermined input as an input for disabling an input interface of a multimedia device; (b) receiving the first predetermined input at the multimedia device; and (c) in response to receiving the first predetermined input, disabling the input interface of the multimedia device, wherein disabling the input interface of the multimedia device comprises ignoring communications received through the input interface.

According to an embodiment of the invention, the instructions are further operable to cause one or more processors to perform the operations comprising: (a) establishing a second predetermined input as an input for enabling the input interface of the multimedia device; (b) receiving the second predetermined input at the multimedia device; and (c) in response to receiving the second predetermined input, enabling the input interface of the multimedia device.

According to an embodiment of the invention, the instructions are further operable to cause one or more processors to perform the operations comprising, outputting an indication of the input interface being disabled.

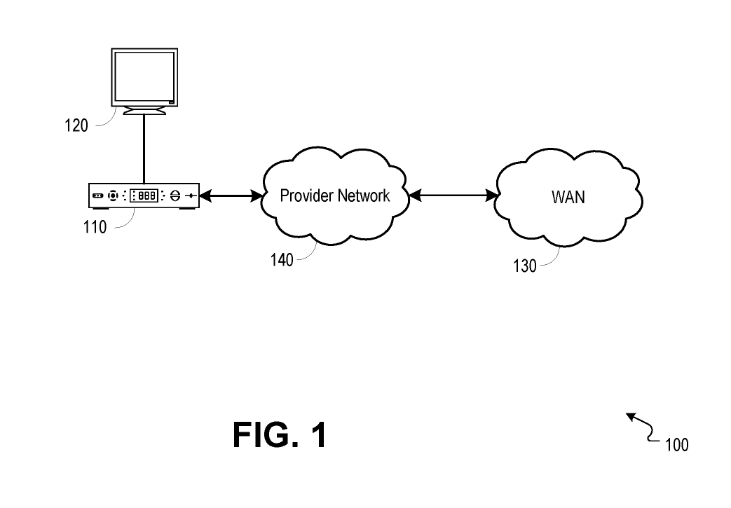

FIG. 1 is a block diagram illustrating an example network environment 100 operable to facilitate a disabling of a remote control unit for a multimedia device. In embodiments, one or more multimedia devices 110 (e.g., set-top box (STB), mobile devices, tablets, gaming consoles, pluggable content-streaming devices, etc.) may provide video and/or data services to a subscriber. For example, a multimedia device 110 may output multimedia content to a display device 120 (e.g., television).

In embodiments, a multimedia device 110 may receive multimedia content for delivery to a display device 120 from an upstream wide area network (WAN) 130 through a connection to a provider network 140. The multimedia device 110 may receive the multimedia content through a direct connection to the provider network 140 or may receive the multimedia content through another device. For example, the multimedia device 110 may receive multimedia content from an access point. An access point may include a gateway device, a modem, a wireless router including an embedded modem, a wireless network extender or any other device operable to deliver services to a multimedia device 110. The multimedia device 110 may receive multimedia content from an access point over a local network (e.g., a local area network (LAN), a wireless local area network (WLAN), a personal area network (PAN), etc.). It will be appreciated that a multimedia device 110 may communicate with an access point over a wired or a wireless connection.

In embodiments, a multimedia device 110 may be configured to enable or disable an input device or input interface. For example, the multimedia device 110 may enable or disable a control device (e.g., enable or disable the operation of a RCU (remote control unit)) in response to receiving a predefined input. The predefined input may be the depressing of a certain button or the depressing of a certain sequence of buttons, and said certain button(s) may be physical button(s) located at the multimedia device 110 or may be button(s) at a remote control unit (RCU) that may be used to interface with the multimedia device 110. For example, the predefined input may be a default or user-established key code or key sequence. The multimedia device 110 may be configured with a default key code, wherein the multimedia device 110 enables or disables functionality of a RCU upon recognition of the default key code. A user may input a key code at the multimedia device 110 and the multimedia device 110 may establish the input key code as the predefined input, wherein the multimedia device 110 enables or disables functionality of a RCU upon recognition of the input key code.

In embodiments, a multimedia device 110 may include a settings menu (e.g., parental control menu) that may be accessed by a user to enable an input interface lock feature. When the input interface lock feature is enabled at a multimedia device 110, the multimedia device 110 may disable an input interface of the multimedia device 110 when a default or user-established key code is received. For example, when the default or user-established key code is received at the multimedia device 110, the multimedia device 110 may disable the operation of a RCU for the multimedia device 110. It should be understood that, while the multimedia device 110 is operating in a locked input interface mode, the multimedia device 110 may recognize and respond to certain communications received from the disabled RCU. For example, the multimedia device 110 may recognize and respond to a request to enable the operation of the RCU. The request to enable the operation of the RCU may be an input of a default or user-established key code. When the default or user-established key code for enabling operation of the RCU is received by the multimedia device 110, the multimedia device 110 may enable operation of the RCU. For example, the multimedia device 110 may enable an input interface for receiving communications from the RCU. It should be understood that the default or user-established key code for disabling operation of an RCU and the default or user-established key code for enabling operation of an RCU may be the same key code or may be different key codes. Disabling an input interface of a multimedia device 110, as used herein, may include configuring the multimedia device 110 to ignore certain communications or signals received at the multimedia device from one or more input devices (e.g., RCU).

In embodiments, the multimedia device 110 may be configured to present or output an indication of the current status of an input interface associated with the multimedia device 110. For example, when the input interface of the multimedia device 110 is disabled (i.e., when the multimedia device 110 is in a locked input interface state or the multimedia device 110 is otherwise ignoring certain communications or signals received from a RCU), the multimedia device 110 may manipulate one or more light indicators (e.g., LED (light-emitting diode) indicators) to indicate that the input interface is disabled, or the multimedia device 110 may output a notification window or message to a display device 120 or other client device, wherein the notification window or message informs a user that the input interface is disabled.

In embodiments, the input interface of the multimedia device 110 may be enabled (i.e., the multimedia device 110 may be brought out of a locked input interface state) when a default or user-established key code for enabling operation of an RCU is received at the multimedia device 110. A master key code may be provided to a user, wherein the multimedia device 110 may be brought out of a locked input interface state when the multimedia device 110 receives an input of the master key code. For example, the master key code may be a different input sequence than the default or user-established key code for enabling operation of the RCU, and the master key code may be a default or user-established button or key sequence that is designated for locking or unlocking an input interface at one or more multimedia devices 110 within a subscriber premise. In embodiments, a multimedia device 110 may be brought out of a locked input interface state (i.e., the input interface may be unlocked) when an unlock message is received from an external device or upstream server. For example, a TR069 diagnostics service may be utilized to unlock an input interface of a multimedia device 110.

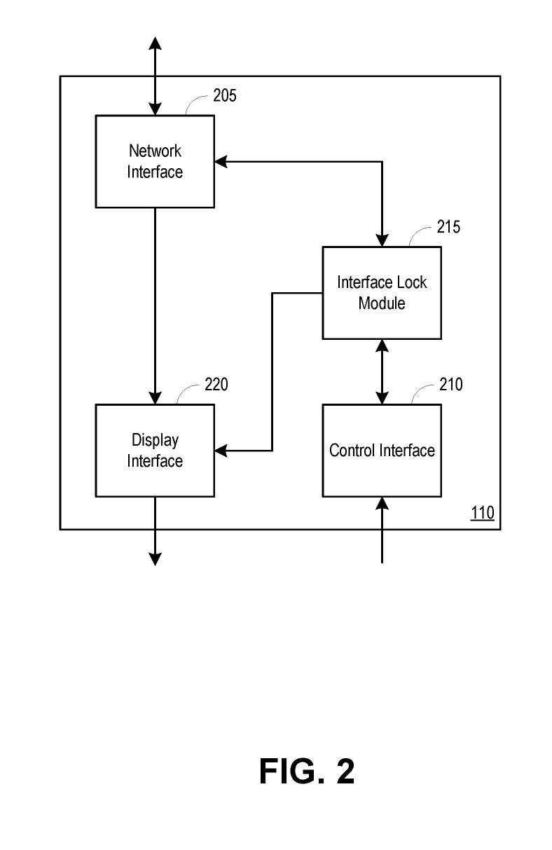

FIG. 2 is a block diagram illustrating an example multimedia device 110 operable to facilitate a disabling of a remote control unit for the multimedia device 110. The multimedia device 110 may include a network interface 205, a control interface 210, an interface lock module 215, and a display interface 220.

In embodiments, multiple services may be received at the multimedia device 110 through a network interface 205. The network interface 205 may be used to receive communications and a variety of multimedia, voice, and/or data services from an external or upstream device or network.

In embodiments, the interface lock module 215 may be configured to enable or disable an input interface (e.g., control interface 210). For example, the interface lock module 215 may enable or disable an input interface (e.g., enable or disable the operation of a RCU (remote control unit)) in response to receiving a predefined input. The predefined input may be the depressing of a certain button or the depressing of a certain sequence of buttons, and said certain button(s) may be physical button(s) located at the multimedia device 110 or may be button(s) at a remote control unit (RCU) that may be used to interface with the multimedia device 110. The predefined input may be received and recognized by the interface lock module 215 through the control interface 210. The control interface 210 may include one or more physical buttons (e.g., physical buttons at a front panel of a multimedia device 110 such as a STB) or may include a receiver (e.g., infrared (IR) receiver, radio-frequency (RF) receiver, Bluetooth interface, etc.) for receiving signals from a remote control unit (RCU). It should be understood that various other methods may be used for delivering a predetermined input to a multimedia device 110.

In embodiments, the predefined input may be a default or user-established key sequence or key code. The interface lock module 215 may be configured with a default key code, wherein the interface lock module 215 enables or disables an input interface (e.g., control interface 210) upon recognition of the default key code. A user may input a key code at the multimedia device 110 and the interface lock module 215 may establish the input key code as the predefined input, wherein the interface lock module 215 enables or disables an input interface upon recognition of the input key code.

When an input interface lock feature is enabled at the multimedia device 110, the interface lock module 215 may disable the control interface 210 when a default or user-established key code is received. For example, when the default or user-established key code is received at the multimedia device 110, the interface lock module 215 may disable the operation of a RCU for the multimedia device 110. The interface lock module 215 may recognize and respond to a request to enable the operation of the RCU. The request to enable the operation of the RCU may be an input of a default or user-established key code. When the default or user-established key code for enabling operation of the RCU is received by the multimedia device 110, the interface lock module 215 may enable operation of the RCU. For example, the interface lock module 215 may enable an input interface for receiving communications from the RCU.

When the control interface 210 is disabled in response to the reception of the predetermined input, the interface lock module 215 may control responses by the multimedia device 110 to communications or signals received through the control interface 210. For example, the interface lock module 215 may ignore certain communications or signals received through the control interface 210 while the control interface 210 is disabled. The interface lock module 215 may ignore control commands received from an RCU, and the interface lock module 215 may respond to an input of a predetermined input designated for unlocking the control interface 210 (e.g., the default or user-established input for enabling the control interface 210).

In embodiments, the interface lock module 215 may be configured to present or output an indication of the current status of an input interface associated with the multimedia device 110. For example, when the control interface 210 is disabled (i.e., when the multimedia device 110 is in a locked input interface state), the multimedia device 110 may manipulate one or more light indicators (e.g., LED (light-emitting diode) indicators) to indicate that the input interface is disabled, or the multimedia device 110 may output a notification window or message to a display device 120 or other client device, wherein the notification window or message informs a user that the input interface is disabled.

In embodiments, the input interface of the multimedia device 110 may be enabled (i.e., the multimedia device 110 may be brought out of a locked input interface state) when a default or user-established key code for enabling operation of an RCU is received at the multimedia device 110 and recognized by the interface lock module 215. A master key code may be provided to a user, wherein the multimedia device 110 may be brought out of a locked input interface state when the multimedia device 110 receives an input of the master key code. In embodiments, a multimedia device 110 may be brought out of a locked input interface state (i.e., the input interface may be unlocked) when an unlock message is received from an external device or upstream server. For example, a TR069 diagnostics service may be utilized to unlock an input interface of a multimedia device 110.

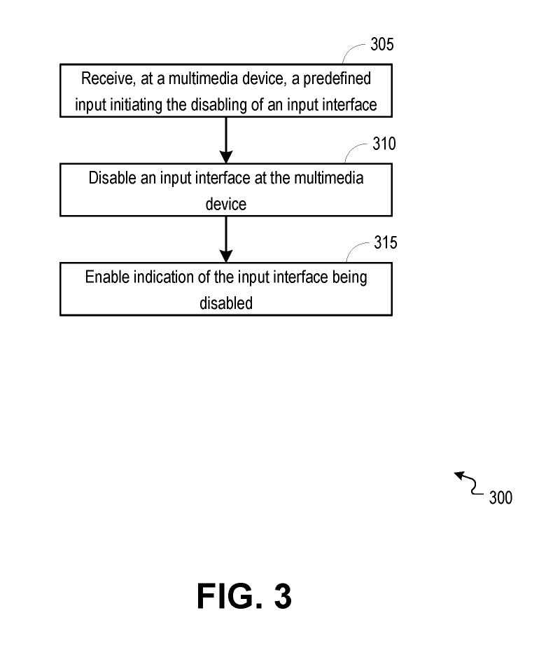

FIG. 3 is a flowchart illustrating an example process 300 operable to facilitate a disabling of a remote control unit for a multimedia device. The process 300 may begin at 305, when a predefined input for initiating a disabling of an input interface is received at a multimedia device (e.g., multimedia device 110 of FIG. 1). The predefined input may be the depressing of a certain button or the depressing of a certain sequence of buttons, and said certain button(s) may be physical button(s) located at the multimedia device 110 or may be button(s) at a remote control unit (RCU) that may be used to interface with the multimedia device 110. The predefined input may be received and recognized by the interface lock module 215 of FIG. 2 through the control interface 210 of FIG. 2. The predefined input may be a default or user-established key code. The multimedia device 110 may be configured with a default key code, wherein the multimedia device 110 disables an input interface upon recognition of the default key code. A user may input a key code at the multimedia device 110 and the multimedia device 110 may establish the input key code as the predefined input, wherein the multimedia device 110 disables an input interface upon recognition of the input key code.

At 310, an input interface of the multimedia device may be disabled. The input interface may be disabled, for example, by the interface lock module 215 of FIG. 2. In embodiments, the interface lock module 215 may disable a control interface 210 of FIG. 2. The interface lock module 215 may disable an interaction between an RCU and the control interface 210. For example, the interface lock module 215 may cause the control interface 210 to ignore communications received from an RCU while the multimedia device 110 is in a locked input interface mode. While operating in the locked input interface mode, the multimedia device 110 may recognize and respond to certain communications received from the disabled RCU. For example, the multimedia device 110 may recognize and respond to a request to enable the operation of the RCU.

At 315, an indication of the input interface being disabled may be enabled. The indication may be enabled, for example, by the interface lock module 215. In embodiments, the multimedia device 110 may present or output an indication of the current status of an input interface associated with the multimedia device 110. For example, when the input interface of the multimedia device 110 is disabled (i.e., when the multimedia device 110 is in a locked input interface state), the multimedia device 110 may manipulate one or more light indicators (e.g., LED (light-emitting diode) indicators) to indicate that the input interface is disabled, or the multimedia device 110 may output a notification window or message to a display device 120 of FIG. 1 or other client device, wherein the notification window or message informs a user that the input interface is disabled.

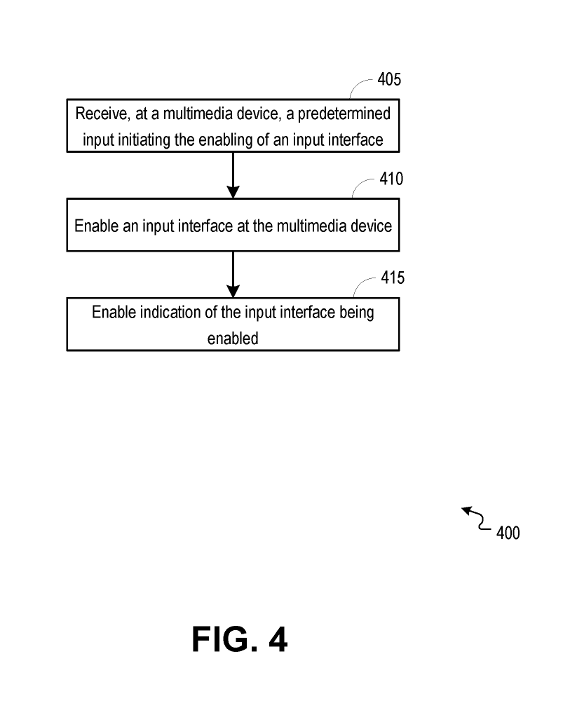

FIG. 4 is a flowchart illustrating an example process 400 operable to facilitate an enabling of a remote control unit for a multimedia device. The process 400 may begin at 405, when a predefined input for initiating an enabling of an input interface is received at a multimedia device (e.g., multimedia device 110 of FIG. 1). The predefined input may be the depressing of a certain button or the depressing of a certain sequence of buttons, and said certain button(s) may be physical button(s) located at the multimedia device 110 or may be button(s) at a remote control unit (RCU) that may be used to interface with the multimedia device 110. The predefined input may be received and recognized by the interface lock module 215 of FIG. 2 through the control interface 210 of FIG. 2. The predefined input may be a default or user-established key code. The multimedia device 110 may be configured with a default key code, wherein the multimedia device 110 enables an input interface upon recognition of the default key code. A user may input a key code at the multimedia device 110 and the multimedia device 110 may establish the input key code as the predefined input, wherein the multimedia device 110 enables an input interface upon recognition of the input key code.

At 410, an input interface of the multimedia device may be enabled. The input interface may be enabled, for example, by the interface lock module 215 of FIG. 2. In embodiments, the interface lock module 215 may enable a control interface 210 of FIG. 2. The interface lock module 215 may enable an interaction between an RCU and the control interface 210. For example, the interface lock module 215 may cause the control interface 210 to accept and respond to communications received from an RCU while the multimedia device 110 is in an unlocked input interface mode.

At 415, an indication of the input interface being enabled may be enabled. The indication may be enabled, for example, by the interface lock module 215. In embodiments, the multimedia device 110 may present or output an indication of the current status of an input interface associated with the multimedia device 110. For example, when the input interface of the multimedia device 110 is enabled (i.e., when the multimedia device 110 is in an unlocked input interface state), the multimedia device 110 may manipulate one or more light indicators (e.g., LED (light-emitting diode) indicators) to indicate that the input interface is enabled, or the multimedia device 110 may output a notification window or message to a display device 120 of FIG. 1 or other client device, wherein the notification window or message informs a user that the input interface is enabled.

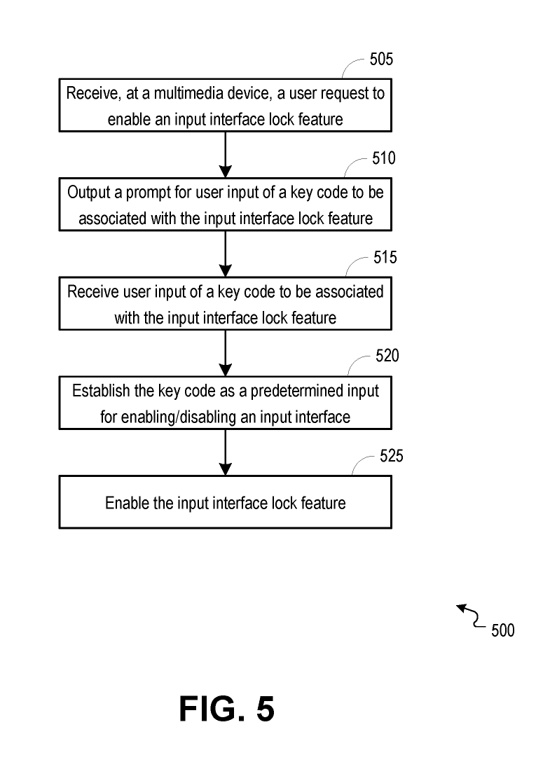

FIG. 5 is a flowchart illustrating an example process 500 operable to facilitate an establishing of a key code for enabling and/or disabling an input interface. The process 500 may begin at 505, when a user request to enable an input interface lock feature is received at a multimedia device (e.g., multimedia device 110 of FIG. 1). In embodiments, a user may access a settings menu provided by the multimedia device 110, and the user may select an option to enable the input interface lock feature. For example, the option to enable the input interface lock feature may be accessed within a parental control menu or settings menu.

At 510, a prompt for user input of a key code to be associated with the input interface lock feature may be output. The prompt for user input of a key code may be output, for example, by the interface lock module 215 of FIG. 2. In embodiments, the prompt for user input of a key code may be output to a display associated with the multimedia device 110 (e.g., display device 120 of FIG. 1).

At 515, user input of a key code to be associated with the input interface lock feature may be received. The user input of the key code may be received, for example, by the interface lock module 215. In embodiments, the user input key code may include a numeric, alphabetic, or alphanumeric string of keys that is to be used as a key code for enabling and/or disabling an input interface associated with the multimedia device 110.

At 520, the key code may be established as a predetermined input for enabling/disabling an input interface. The key code may be established as the predetermined input for enabling/disabling an input interface, for example, by the interface lock module 215. In embodiments, the interface lock module 215 may store the key code and may recognize an input of the key code through an input interface (e.g., control interface 210 of FIG. 2) when the input interface lock feature is enabled at the multimedia device 110.

At 525, the input interface lock feature may be enabled. The input interface lock feature may be enabled, for example, by the interface lock module 215. In embodiments, when the input interface lock feature is enabled, the interface lock module 215 may recognize an input of the key code through an input interface (e.g., control interface 210 of FIG. 2). If the input interface is unlocked when the key code is received, the interface lock module 215 may lock the input interface. If the input interface is locked when the key code is received, the interface lock module 215 may unlock the input interface.

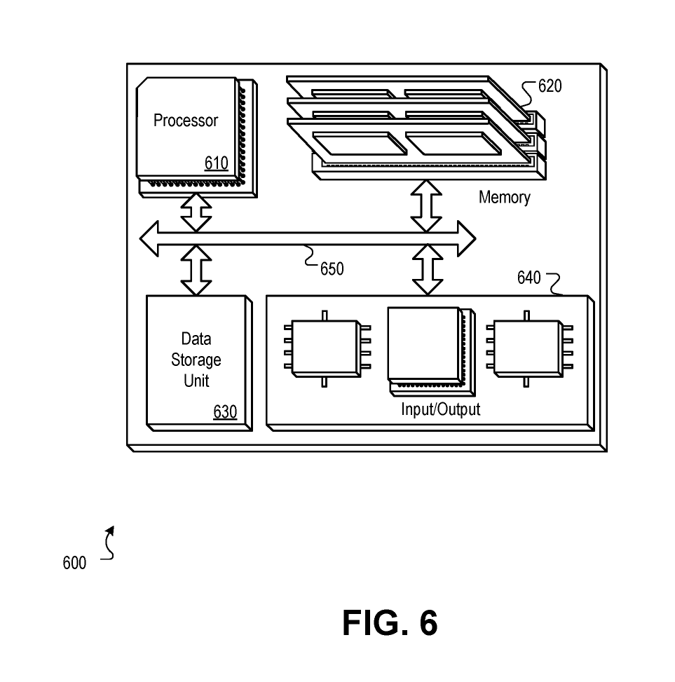

FIG. 6 is a block diagram of a hardware configuration 600 operable to facilitate a disabling of a remote control unit for a multimedia device. The hardware configuration 600 can include a processor 610, a memory 620, a storage device 630, and an input/output device 640. Each of the components 610, 620, 630, and 640 can, for example, be interconnected using a system bus 650. The processor 610 can be capable of processing instructions for execution within the hardware configuration 600. In one implementation, the processor 610 can be a single-threaded processor. In another implementation, the processor 610 can be a multi-threaded processor. The processor 610 can be capable of processing instructions stored in the memory 620 or on the storage device 630.

The memory 620 can store information within the hardware configuration 600. In one implementation, the memory 620 can be a computer-readable medium. In one implementation, the memory 620 can be a volatile memory unit. In another implementation, the memory 620 can be a non-volatile memory unit.

In some implementations, the storage device 630 can be capable of providing mass storage for the hardware configuration 600. In one implementation, the storage device 630 can be a computer-readable medium. In various different implementations, the storage device 630 can, for example, include a hard disk device, an optical disk device, flash memory or some other large capacity storage device. In other implementations, the storage device 630 can be a device external to the hardware configuration 600.

The input/output device 640 provides input/output operations for the hardware configuration 600. In one implementation, the input/output device 640 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for receiving and/or transmitting communications to a control device (e.g., RCU) and/or one or more interfaces for outputting video and/or data services to a device (e.g., multimedia device 110 of FIG. 1, display device 120 of FIG. 1, client device, etc.). In another implementation, the input/output device can include driver devices configured to send communications to, and receive communications from one or more networks (e.g., WAN 130 of FIG. 1, provider network 140 of FIG. 1, local network, etc.).

Those skilled in the art will appreciate that the invention described herein improves upon methods and systems for controlling access to multimedia devices. Methods, systems, and computer readable media may be operable to facilitate a disabling of a remote control unit for a multimedia device. A multimedia device may be configured with a predetermined input for enabling/disabling an input interface of the multimedia device. An interface lock feature may be enabled at the multimedia device, and when the predetermined input is received at the multimedia device, an input interface of the multimedia device may be enabled or disabled. When the input interface of the multimedia device is disabled, a control device such as a remote control unit may be precluded from operating with the multimedia device.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
establishing a first predetermined input as an input for disabling an input interface of a multimedia device;
receiving the first predetermined input at the multimedia device; and
in response to receiving the first predetermined input, disabling the input interface of the multimedia device, wherein disabling the input interface of the multimedia device comprises ignoring communications received through the input interface.

2. The method of claim 1, wherein the first predetermined input comprises a user-established string of characters.

3. The method of claim 1, wherein the first predetermined input comprises a default string of characters.

4. The method of claim 1, further comprising:
establishing a second predetermined input as an input for enabling the input interface of the multimedia device;
receiving the second predetermined input at the multimedia device; and
in response to receiving the second predetermined input, enabling the input interface of the multimedia device.

5. The method of claim 4, wherein the first predetermined input and the second predetermined input comprise the same string of characters.

6. The method of claim 4, wherein disabling the input interface of the multimedia device comprises causing the input interface to ignore communications received through the input interface except for an input of the second predetermined input.

7. The method of claim 1, further comprising:
outputting an indication of the input interface being disabled.

8. An apparatus comprising:
a module configured to establish a first predetermined input as an input for disabling an input interface, wherein the input interface is configured to be used to receive the first predetermined input, and wherein the input interface is configured to receive input communications from a user; and
wherein the module is further configured to, in response to receiving the first predetermined input, disable the input interface, wherein disabling the input interface comprises ignoring communications received through the input interface.

9. The apparatus of claim 8, wherein the first predetermined input comprises a user-established string of characters.

10. The apparatus of claim 8, wherein:
the module is further configured to establish a second predetermined input as an input for enabling the input interface;
the interface is further configured to receive the second predetermined input; and
the module is further configured to, in response to receiving the second predetermined input, enable the input interface.

11. The apparatus of claim 10, wherein the first predetermined input and the second predetermined input comprise the same string of characters.

12. The apparatus of claim 10, wherein disabling the input interface comprises causing the interface to ignore communications received through the input interface except for an input of the second predetermined input.

13. The apparatus of claim 8, wherein the module is further configured to output an indication of the input interface being disabled.

14. One or more non-transitory computer readable media having instructions operable to cause one or more processors to perform the operations comprising:
establishing a first predetermined input as an input for disabling an input interface of a multimedia device;
receiving the first predetermined input at the multimedia device; and
in response to receiving the first predetermined input, disabling the input interface of the multimedia device, wherein disabling the input interface of the multimedia device comprises ignoring communications received through the input interface.

15. The one or more non-transitory computer-readable media of claim 14, wherein the first predetermined input comprises a user-established string of characters.

16. The one or more non-transitory computer-readable media of claim 14, wherein the first predetermined input comprises a default string of characters.

17. The one or more non-transitory computer-readable media of claim 14, wherein the instructions are further operable to cause one or more processors to perform the operations comprising:
establishing a second predetermined input as an input for enabling the input interface of the multimedia device;
receiving the second predetermined input at the multimedia device; and
in response to receiving the second predetermined input, enabling the input interface of the multimedia device.

18. The one or more non-transitory computer-readable media of claim 17, wherein the first predetermined input and the second predetermined input comprise the same string of characters.

19. The one or more non-transitory computer-readable media of claim 17, wherein disabling the input interface of the multimedia device comprises causing the input interface to ignore communications received through the input interface except for an input of the second predetermined input.

20. The one or more non-transitory computer-readable media of claim 14, wherein the instructions are further operable to cause one or more processors to perform the operations comprising:
outputting an indication of the input interface being disabled.
